(19) United States
(12) Patent Application Publication
(10) Pub. No.: US 2013/0151969 A1
(43) Pub. Date: Jun. 13, 2013

(54) Content Identification and Linking

(71) Applicants: Timothy D. Campbell, Lexington, KY (US); Gerald Geurkink, Lexington, KY (US); Nicholas Evan Solon, Lexington, KY (US); Scott Bowden, Lexington, KY (US)

(72) Inventors: Timothy D. Campbell, Lexington, KY (US); Gerald Geurkink, Lexington, KY (US); Nicholas Evan Solon, Lexington, KY (US); Scott Bowden, Lexington, KY (US)

(73) Assignee: IHIGH.COM, INC., Lexington, KY (US)

(21) Appl. No.: 13/314,643

(22) Filed: Dec. 8, 2011

(51) Int. Cl. G06F 3/00

(52) U.S. Cl. 715/720

(57) ABSTRACT

Included are embodiments for content identification and linking. More specifically, some embodiments include receiving content from a user and providing a first user interface that comprises the content. The first user interface may include an action identity option to identify an action in the content. The first user interface may further include a time identity option to identify a time that the action occurred in the content. Similarly, some embodiments include provide a second user interface that includes a clip option to provide a subset of the content. The second user interface may include a play clip option to play the subset of the content, beginning at the time the action occurred.

### BACKGROUND

1. Field

Embodiments provided herein generally relate to identification and linking of content, and particularly to identifying an action in a piece of content for linking to a profile.

2. Technical Background

As a background, many athletes, musicians, actors, and/or other performers desire to present video clips of their performances to perspective college coaches, perspective professional coaches, agents, talent scouts, parents, friends, and others. However, in many current solutions, the content that is provided includes videos of an entire performance in which the performer participated. While the entire video is helpful to the viewer to determine the level of performance of the performer, oftentimes the interesting portion of the video (such as a touchdown made by the performer) is buried inside hours of footage. While many performers create highlight films that include select portions of a number of performances, these highlight films are often time consuming and expensive to create.

### SUMMARY

Included are embodiments for content identification and linking. More specifically, some embodiments include receiving content from a user and providing a first user interface that comprises the content. The first user interface may include an action identity option to identify an action in the content. The first user interface may further include a time identity option to identify a time that the action occurred in the content. Similarly, some embodiments include providing a second user interface that includes a clip option to provide a subset of the content. In some embodiments, the second user interface may include a play clip option to play the subset of the content, beginning at the time the action occurred.

Also included are embodiments of a system. Some embodiments of a system include a memory component that stores logic that, when executed by the system, causes the system to receive video content on a performance social network. The performance social network may include a group profile for a group and a performer profile for a performer, the performer profile being established within the group profile. In some embodiments, the logic further causes the system to provide the video content on the performance social network, provide an action identity option on the performance social network to identify an action in the video content, and provide a time identity option to identify a time that the action occurred in the video content. Similarly, in some embodiments, the logic causes the system to provide a clip option on the performance social network for identifying a subset of the video content, provide a performer identity option on the performance social network for identifying the performer performing the action within the video content, and provide a play clip option on the performance social network to play the subset of the video content, beginning at the time the action occurred.

Still some embodiments include a non-transitory computer-readable medium that stores logic that, when executed by a computer, causes the computer to receive video content on a performance social network, provide the video content on the performance social network, and provide an action identity option on the performance social network to identify an action in the video content. Similarly, in some embodiments the logic causes the computing device to provide a time identity option to identify a time that the action occurred in the video content, provide a clip option on the performance social network for identifying a subset of the video content, and provide a performer identity option on the performance social network for identifying a performer performing the action within the video content. In still some embodiments, the logic causes the computing device to provide a play clip option on the performance social network to play the subset of the video content, beginning at the time the action occurred.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for content identification and linking, according to one or more embodiments shown and described herein;

FIG. 2 depicts a remote computing device for content identification and linking, according to one or more embodiments shown and described herein;

FIG. 3 depicts a user interface for providing a performance social network, according to one or more embodiments shown and described herein;

FIG. 4 depicts a user interface for providing a group page on a performance social network, according to one or more embodiments shown and described herein;

FIG. 5 depicts a user interface for providing a roster of performers, according to one or more embodiments shown and described herein;

FIG. 6 depicts a user interface for providing a performer profile, according to one or more embodiments shown and described herein;

FIG. 7 depicts a user interface for providing content into a performance social network, according to one or more embodiments shown and described herein;

FIG. 8 depicts a user interface for identifying a performer in content, according to one or more embodiments shown and described herein;

FIG. 9 depicts a user interface that identifies a performer in the content, according to one or more embodiments shown and described herein;

FIG. 10 depicts a user interface that provides a plurality of different portions of content for a single performer and/or group, according to embodiments disclosed herein;

FIG. 11 depicts a user interface that provides a performer profile in a performance social network, according to one or more embodiments shown and described herein; and

FIG. 12 depicts a flowchart for identifying content, according to one or more embodiments shown and described herein.

### DETAILED DESCRIPTION

Accordingly, embodiments disclosed herein may be configured to provide an interface for allowing the tagging of actions in content, as well as for captioning the tagged portions. As an example, if a user uploads a video of a sporting event, music recital, movie, etc., the user can tag himself/herself at various points of the video. The tagging may be placed just before and/or after a performance of interest by the performer (such as a football player scoring a touchdown). The tagging may include the point in the video in which the play begins, the point in which the play ends, the name of the performer(s) involved in the performance of interest, the team name, the coach name, the venue, the performer position, and/or other information. This tagging data may then be stored as metadata with the video. Accordingly, the tags may be associated with a plurality of different clips of content, which may subsequently displayed such that the user (or others) may easily jump to the point(s) in the video that have been tagged. Additionally, this tagging allows a search engine to easily provide a portion of the video in which the performance of interest occurred.

As an example, if a search engine performs a web crawl or other mechanism to locate content for indexing, the search engine may locate the tagged video. Because the search engine also analyzes the metadata associated with the video, the search engine may provide the video when the performer's name is searched by a searcher. Additionally, as the tagging data indicates a time in the video when the play occurred, the search engine may provide user options to the searcher for viewing that particular portion of the video. In some embodiments, the search engine may provide a video thumbnail by cropping the video to only include the portion of the video being searched.

Similarly, in some embodiments, the video tagging functionality may be provided within the context of a performance social network. A performance social network may be configured as a social network for performers, such as athletes, musicians, actors, etc. to display their talents. As an example, if a user uploads a basketball game to the performance social network, the user may tag a particular player in the game. The tagging may be performed manually, such as by selecting a tagging option when a performance of interest occurs, identifying a player of interest for the tag, and entering the desired information, such as team name, date, final score, statistics, etc.

Similarly, in some embodiments, the video may be tagged automatically. As an example, if a user uploads a video of a soccer game, the user may then enter a team name and/or player name. The performance social network may then determine whether the player (and/or any player on the team) has a profile with the performance social network. If so, the performance social network can scan the content to identify in which portions the player is featured. The performance social network may also identify in which plays that player scored a goal, touched the ball, entered the game, left the game, etc. This identification may occur by utilizing a marker on the player, such as a jersey number, jersey color, bar code, etc. and/or via face recognition, body recognition, etc.

Regardless, once the player is identified in the video, the performance social network can tag points in the video where a performance of interest occurs that involves that player. As discussed above, the tagging may include various information including player name, team name, current score of the game (at that point in the content), final score of the game, player statistics, team statistics, etc. Additionally, as the player and/or team statistics may be determined by the performance social network, these statistics may be linked to a profile of the player. Accordingly, when the player is featured in the video, data from the player's profile may be collected and included with the video. As an example, when the player scores a goal, the player's picture, season statistics, game statistics, and/or other information may be provided with the video. Similarly, when a user visits the player's profile, the player's statistics that are compiled from the videos may be provided.

Additionally, a highlight video may also be provided in the player profile that may be dynamically configured based on a user selection. As an example, the player profile may include a plurality of different game videos. Additionally, some embodiments include an option to provide a highlight video of the player scoring goals against a particular team. Upon this user selection, the performance social network may compile the tagged portions of those videos where the player scores on the specified team. If the user is the player, an option may be provided for saving the highlight video on the player's profile for display to the social media public. If however, the user is not the player, the highlight video may be sent (and/or linked) to the user so that it is not displayed to the public.

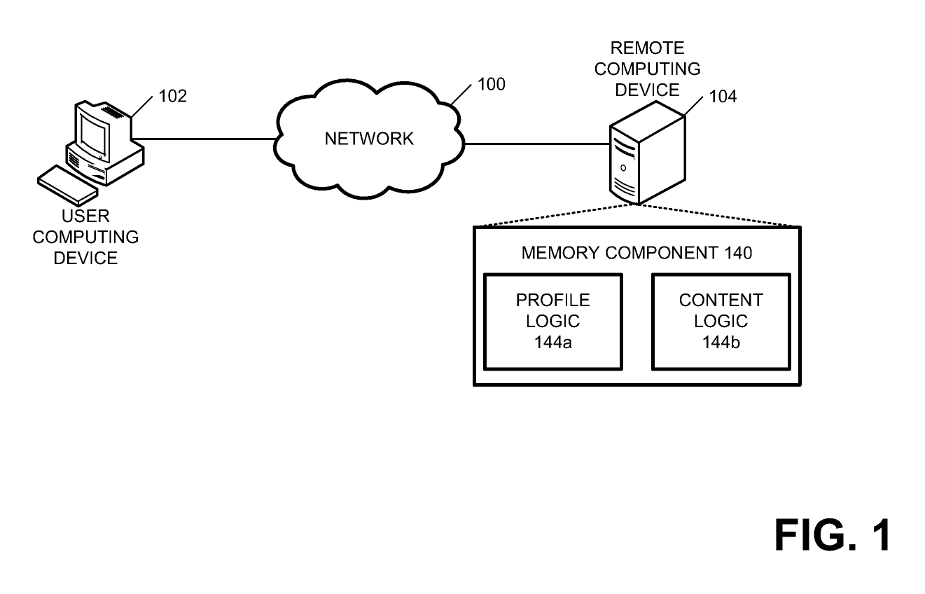

Referring now to the drawings, FIG. 1 depicts a computing environment for content identification and linking, according to one or more embodiments shown and described herein. As illustrated in FIG. 1, a network 100 may include a wide area network, such as the Internet, a local area network (LAN), a mobile communications network, a public service telephone network (PSTN) and/or other network and may be configured to electronically couple a user computing device 102 and a remote computing device 104.

More specifically, the user computing device 102 may be configured to upload content, such as audio data streams, video data streams, imagery, and/or other data to the remote computing device 104. The remote computing device 104 may include a memory component 140 that stores profile logic 144a, content logic 144b, and/or other logic and may be configured to provide a performance social network. The remote computing device 104 may also receive content, such audio and/or video from the user computing device 102. The remote computing device 104 may also receive user input that identifies performers in the content and at what time in the content that certain actions occur. The remote computing device 104 may provide the content and/or portions of the content as part of the performance social network, according to the identified actions.

It should be understood that while the user computing device 102 and the remote computing device 104 are depicted as personal computers and/or servers, these are merely examples. More specifically, in some embodiments, any type of computing device (e.g. mobile computing device, personal computer, server, etc.) may be utilized for any of these components. Additionally, while each of these computing devices is illustrated in FIG. 1 as a single piece of hardware, this is also an example. More specifically, each of the computing devices 102, 104 may represent a plurality of computers, servers, databases, etc.

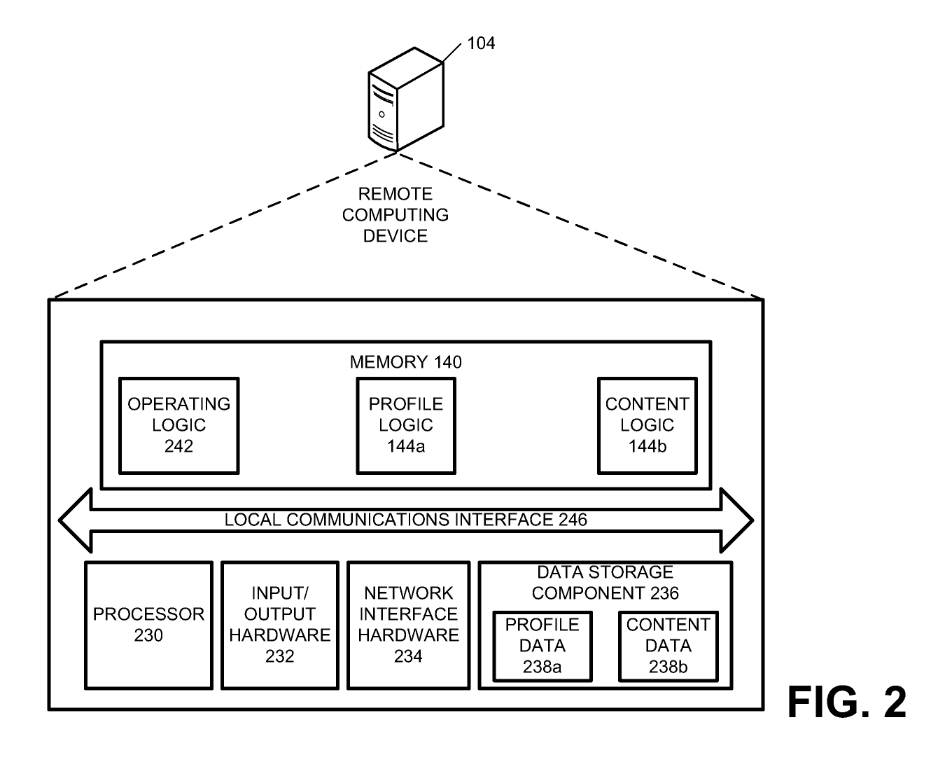

FIG. 2 depicts a remote computing device for content identification and linking, according to one or more embodiments shown and described herein. In the illustrated embodiment, the remote computing device 104 includes a processor 230, input/output hardware 232, network interface hardware 234, a data storage component 236 (which stores profile data 238a and content data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

Additionally, the memory component 140 may be configured to store operating logic 242, the profile logic 144a, and the content logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device.

Included in the memory component 140 are the operating logic 242, the profile logic 144a and the content logic 144b. The operating logic 242 may include an operating system and/or other software for managing components of the remote computing device 104. Similarly, the profile logic 114a may be configured to cause the remote computing device 104 to create a performance social network. As discussed in more detail below, a performance social network may provide users with options for creating a group profile, a performer profile, as well as options for the performer profile to be linked to one or more group profiles, such as part of a sports team. The performance social network may additionally provide content regarding the group and/or performer such as audio, video, and/or text related to games and/or other performances of the group and/or performer. Additionally, content logic 144b may reside in the memory component 140 and may be configured to cause the processor 230 to receive content from the user computing device 102, as well as provide the content to other user computing devices.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104. It should also be understood that, while the remote computing device 104 in FIGS. 1 and 2 is illustrated as a single system, this is also merely an example. In some embodiments, the content providing functionality is implemented separately from the advertisement functionality, which may be implemented with separate hardware, software, and/or firmware.

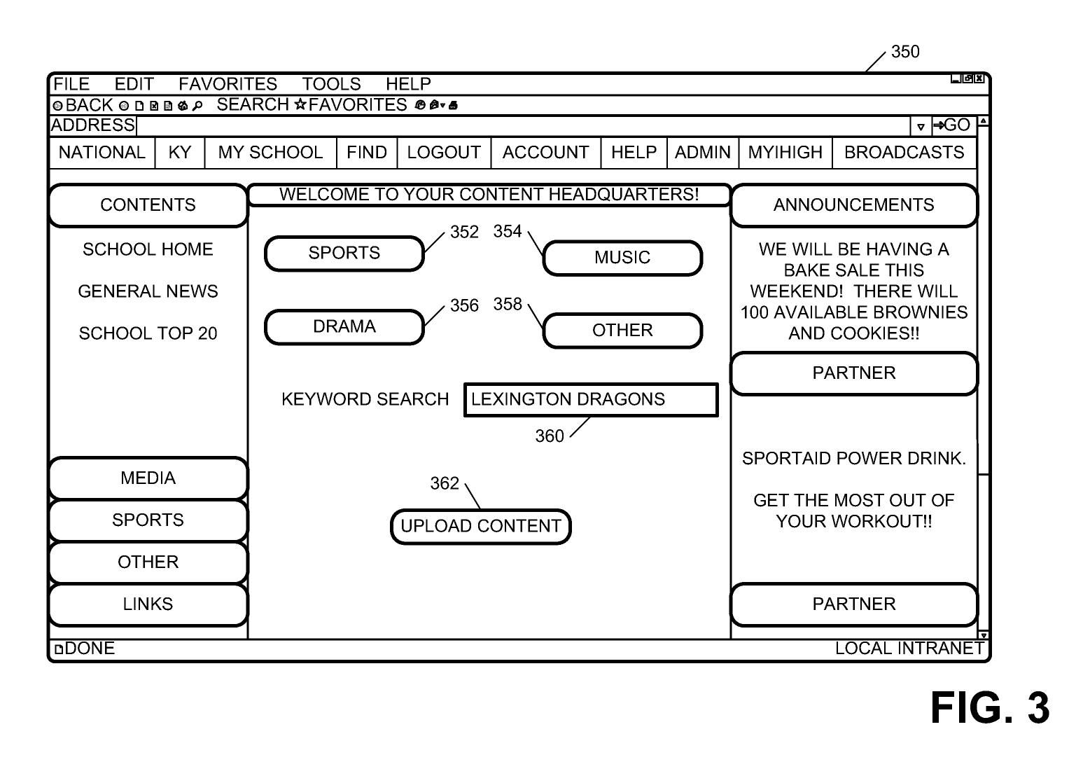

FIG. 3 depicts a user interface 350 for providing a performance social network, according to one or more embodiments shown and described herein. As illustrated, the user interface 350 may be part of a performance social network, which may provide a two-tier (more than two-tier) platform, where groups, such as sports teams may have a group profile. The group profile may include group members, who may have individual profiles. Depending on the particular embodiment, the administrator of the group profile may be provided with one or more options determine which performers are part of the group profile, as well as one or more options to dictate content associated with one or more of the performers of the group.

More specifically, the user interface 350 includes a sports option 352, a music option 354, a drama option 356, and an other option 358. Also included is a keyword search prompt 360 and an upload content option 362. The sports option 352 may provide a user with group profiles of sports teams, while the music option 354 may provide the user with group profiles of musical groups. The drama option 356 may provide the user with group profiles of dramatic groups, such as movie casts, play casts, etc. The other option 358 may provide the user with profiles of other types of groups.

Additionally, if the user is searching for a specific performer and/or group, the user may perform a keyword search for the desired result, using the keyword search prompt 360. The upload content option 362 provides the user with options for uploading audio, video, text, and/or other content, as described below.

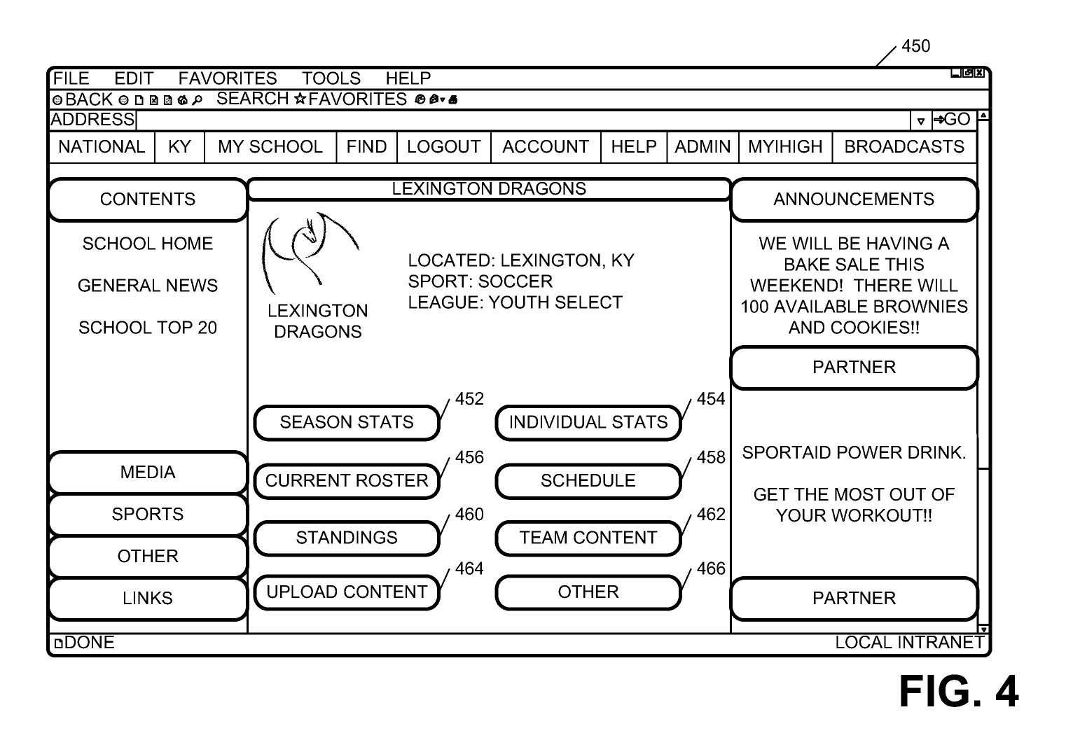

FIG. 4 depicts a user interface 450 for providing a group page on a performance social network, according to one or more embodiments shown and described herein. As illustrated, the user interface 450 may be provided in response to a user performing a keyword search for “Lexington Dragons” in the user interface 350 (FIG. 3). Similarly, the user interface 450 may be provided in response to selecting the sports option 352 and otherwise navigating to the user interface 450. The user interface 450 may include information about the “Lexington Dragons,” which may be a sports team, drama cast, musical group, and/or other type of performance group. Accordingly, the user interface 450 may include a season stats option 452, an individual stats option 454, a current roster option 456, a schedule option 458, a standings option 460, a team content option 462, an upload content option 464, and an other option 466.

More specifically, by selecting the season stats option 452, the user may be provided with one or more season statistics for the Lexington Dragons as a group. The individual stats option 454 may be configured to provide statistics for specific performers that are part of the group. The current roster option 456 may be configured to provide the user with the current roster of the group. The schedule option 458 may provide the user with a listing of events (such as games for the Lexington Dragons) that are occurring in the near future. The standings option 460 may provide standings for the league that the group is a member. The team content option 462 may provide options to view and/or identify content associated with the group. The upload content option 464 may provide options to upload, view, and/or identify action within the content, as described in more detail below. The other option 466 may provide other options related to the group.

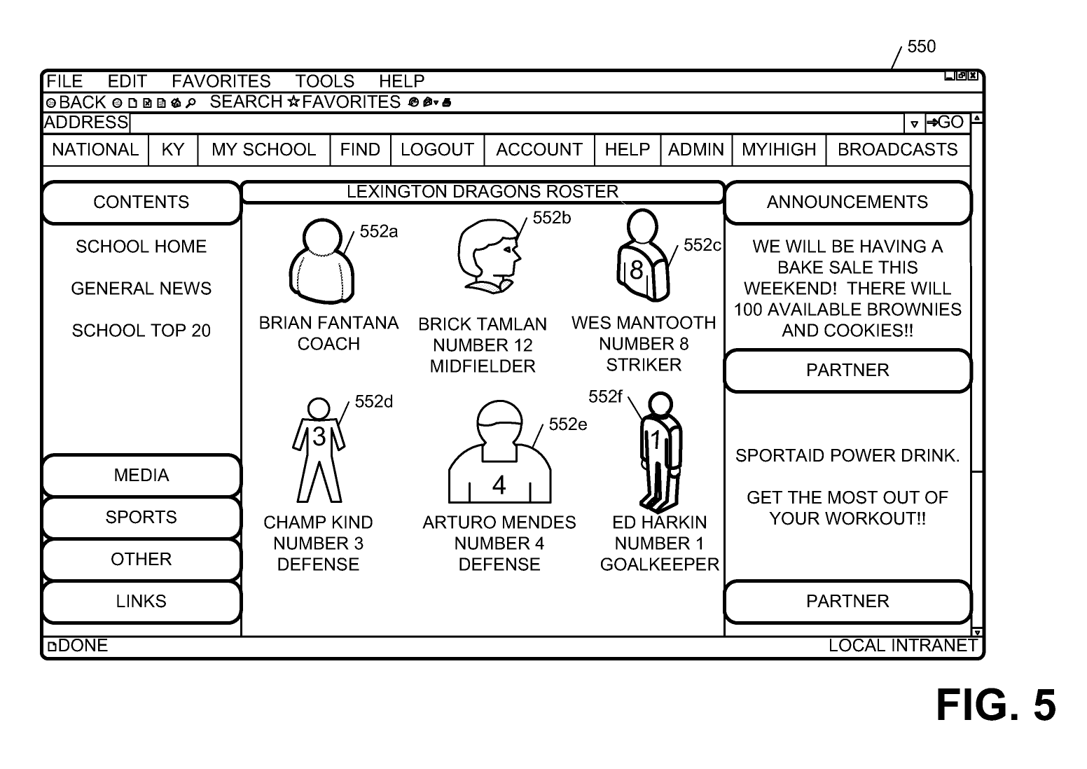

FIG. 5 depicts a user interface 550 for providing a roster of performers, according to one or more embodiments shown and described herein. As illustrated, in response to selecting the current roster option 456 from FIG. 4, the user interface 550 may be provided with a listing of performers 552a-552f that are a part of the group. In the example of FIG. 5, the Lexington Dragons is a soccer team and the performers include a coach 552a, a midfielder 552b, a striker 552c, a first defender 552d, a second defender, and a goalkeeper 552f. The coach (or other entity) may be the administrator of the Lexington Dragons' profile and may thus determine the layout, the performers, the content, etc. that is provided on the profile. In some embodiments, the administrator may additionally have rights to control the content and layout of the individual performer profiles that are associated with the group.

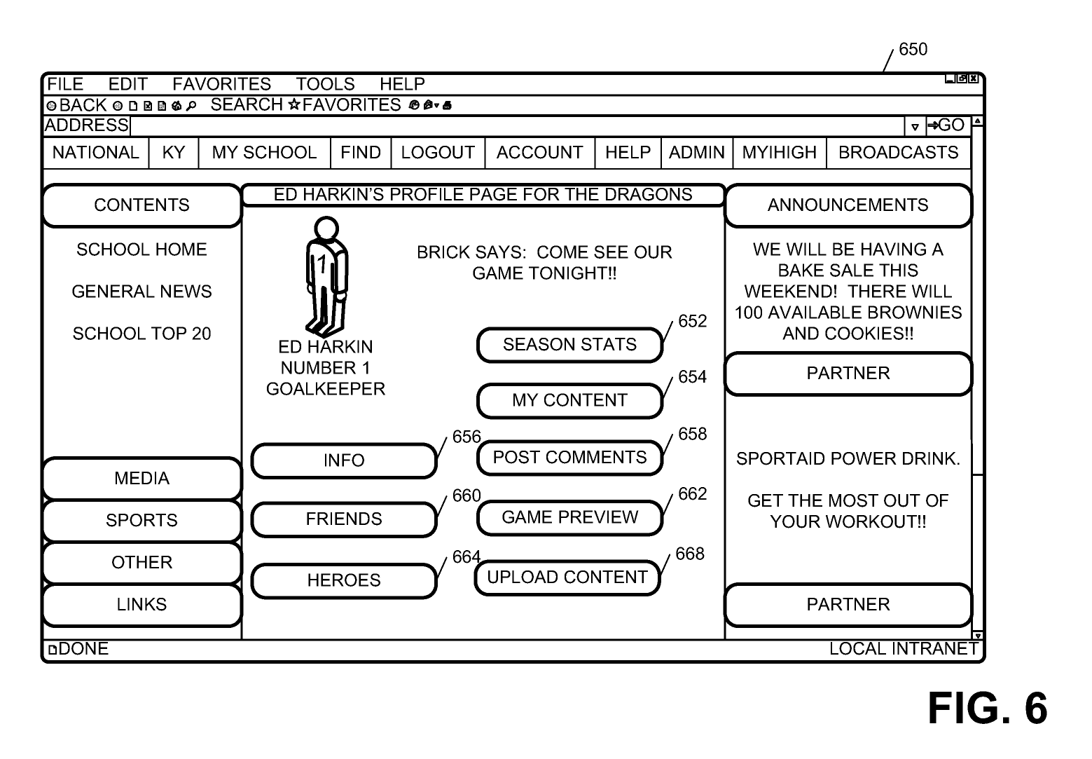

FIG. 6 depicts a user interface 650 for providing a performer profile, according to one or more embodiments shown and described herein. As illustrated, the user interface 650 may be provided in response to selection of the goalkeeper 552f from FIG. 5. The user interface 650 may include a season stats option 652, a my content option 654, an info option 656, a post comments option 658, a friends option 660, a game preview option 662, a heroes option 664, and an upload content option 668.

More specifically, in response to selection of the season stats option 652, the user may be provided with individual season statistics of the performer of the user interface 650. In response to selection of the my content option 654, the user may be provided with content that includes that performer. In response to selection of the info option 656, the user may be provided with information about the performer. In response to selection of the post comments option 658, the user may be provided with additional options to post comments for others to view. In response to selection of the friends option 660, the user may be provided with a listing of friends of the performer on the performance social network. In response to selection of the game preview option 662, the user may be provided with information regarding the performer's next game. Information, such as trends, historical data, predictions, etc. may be provided. In response to selection of the heroes option 664, the user may be provided with information related to one or more heroes of the performer. In response to selection of the upload content option 668, the user may be provided with an option to upload, view, and/or identify content.

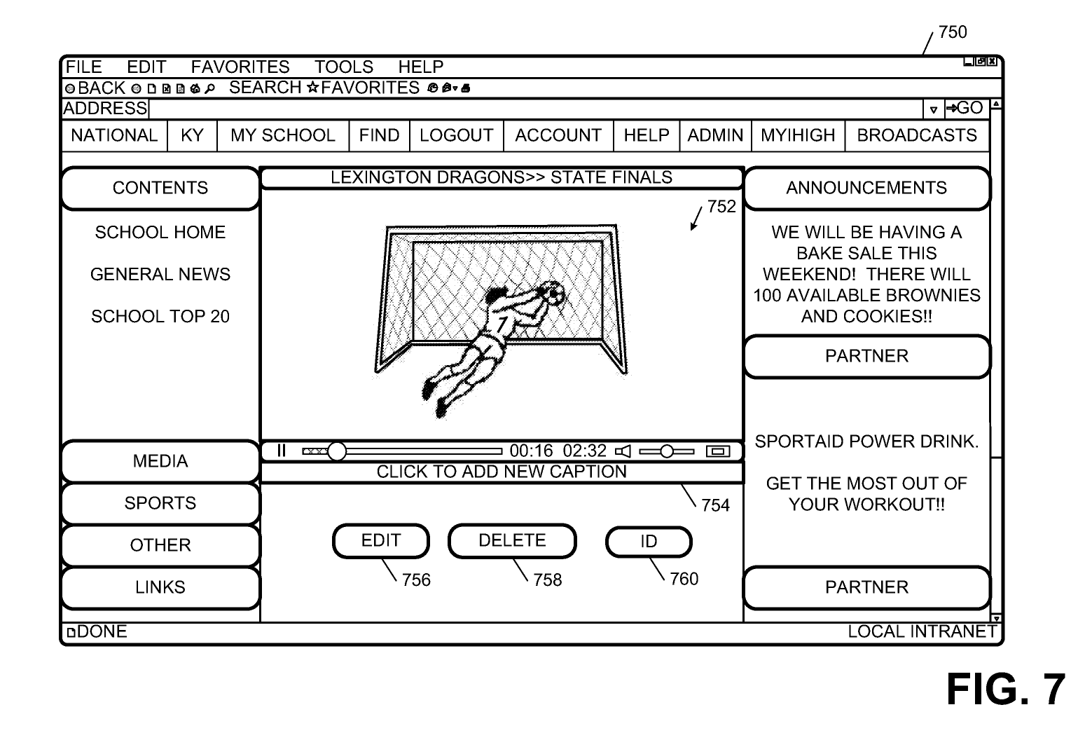

FIG. 7 depicts a user interface 750 for providing content into a performance social network, according to one or more embodiments shown and described herein. As illustrated, the user interface 750 may be provided in response to selection of the upload content option 362 (FIG. 3), the team content option 462 (FIG. 4), and/or the upload content option 464 (FIG. 4). Additionally, the user interface 750 includes a content area 752 for providing content. The content may include audio, video, and/or other types of content that may be uploaded to the performance social network by the user. Also included are a caption option 754, an edit option 756, a delete option 758, and an action identity option 760.

More specifically, the caption option 754 may provide the user with the ability to caption the content. As an example, as illustrated in the content area 752, the state finals soccer match is being provided. Accordingly, the user may select the caption option 754, which allows the user to include this information as a caption to the content. The captions may include a time, date, teams, players, score, and/or other data associated with the content. Additionally, if the user wishes to edit the content, the user may select the edit option 756. The edit option may provide options for the user to cut, copy, reduce resolution, increase resolution, zoom, center, etc. Similarly, if the user wishes to delete the uploaded content, the user may select the delete option 758. Further, if the user wishes to identify and/or tag a point in the content, the user may select the action identity option 760. More specifically, as illustrated in the content area 752, player number 1 made a save sixteen seconds into the game. As such, the user may select the action identity option 760 to tag that point in the content, as well as identify the player involved, the teams involved, the action that occurred, etc. Further, depending on the embodiment, the user may select the action identity option 760 again to signify the end of the action.

It should be understood that while in some embodiments, the user may identify the teams, players, actions, etc.; in some embodiments the performance social network may utilize image and/or video recognition to identify this information. Similarly, in some embodiments, the performance social network may make determinations of this data and provide an option to the user for confirmation and/or editing.

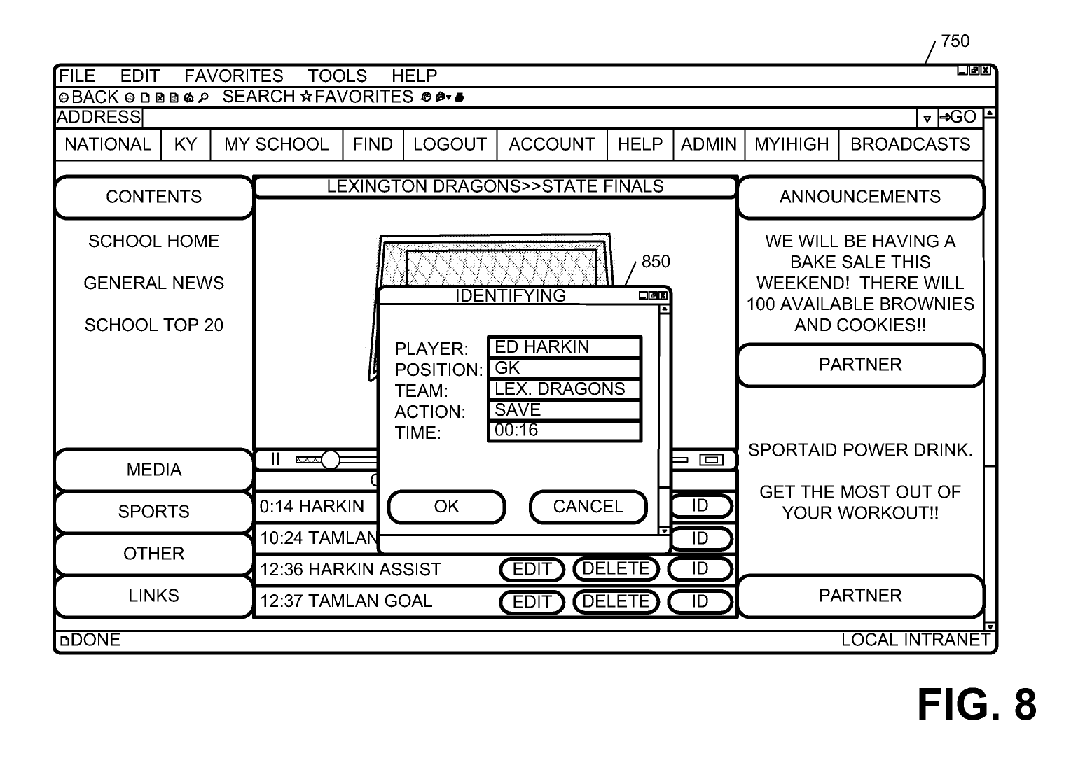

FIG. 8 depicts a user interface 850 for identifying a performer in content, according to one or more embodiments shown and described herein. As illustrated, in response to the action identity option 760 of FIG. 7, the user interface 850 may be provided and may include prompts for the user to enter (and/or edit) information, such as a player identity option, a position identity option, a team identity option, an action identity option, and a time identity option. Upon entering the desired information, the user may select OK, which will associate a metatag with that portion of the content.

It should be understood that, while the user may identify individual player data in the user interface 750, this is merely an example. More specifically, in some embodiments, the user interface 850 may be configured to receive a group statistic that is related to the performance. While the group statistics may be specifically determined, in some embodiments, when the user identifies a performer statistic, the performance social network, can determine the group that the action belongs and automatically update the group statistics.

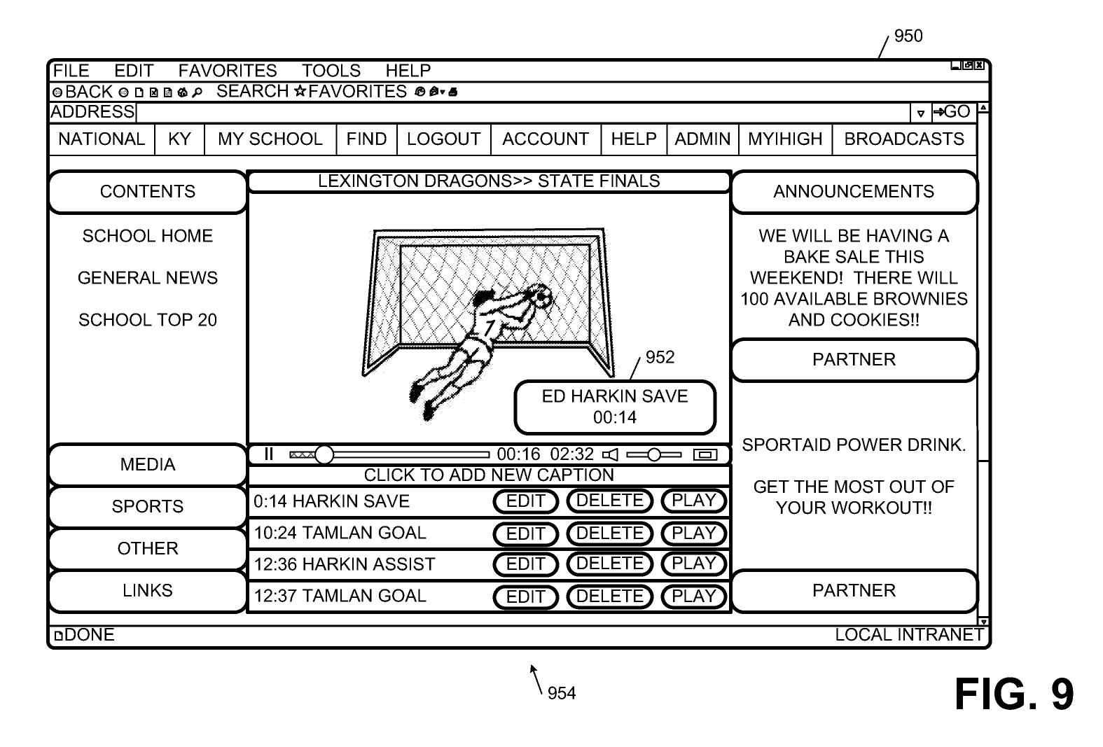

FIG. 9 depicts a user interface 950 that identifies a performer in the content, according to one or more embodiments shown and described herein. As illustrated, in response to selecting the team content option 462 (FIG. 4), the user interface 950 may be provided. Additionally, as described above, in response to tagging the content of FIG. 8, a caption 952 may automatically be created at the point in the content where the action occurred. Also included in the user interface 950 of FIG. 9 is a tagged content listing area 954, which lists portions of this (and/or other) content of the group. The tagged content listing area 954 includes a plurality of play clip options for playing one or more of the tagged content therein. More specifically, in response to selecting the “Harkin save” option, the user may be provided with a subset of the game footage, which only shows that particular action. Additionally, as the user interface 950 was accessed via the Lexington Dragons group profile, the tagged portions of content may all be associated with Lexington Dragons' performances.

This allows a user to quickly view highlights of individual players, types of plays, etc. Additionally, other options may be provided, such as those that compile highlights of a single game, season, etc. into a single video (and/or audio) stream of content. This compiled highlight stream may be dynamic in that a user may specify designated criteria and the highlight stream may be automatically generated. As an example, if a user desires to see all saves by the Lexington Dragons from the “state finals,” the user may so specify on the performance social network. In response, the user interface 950 may be provided with a video stream that only includes those highlights. Additionally, the user may be provided with options to view particular highlights with the options provided in the tagged content listing area 954.

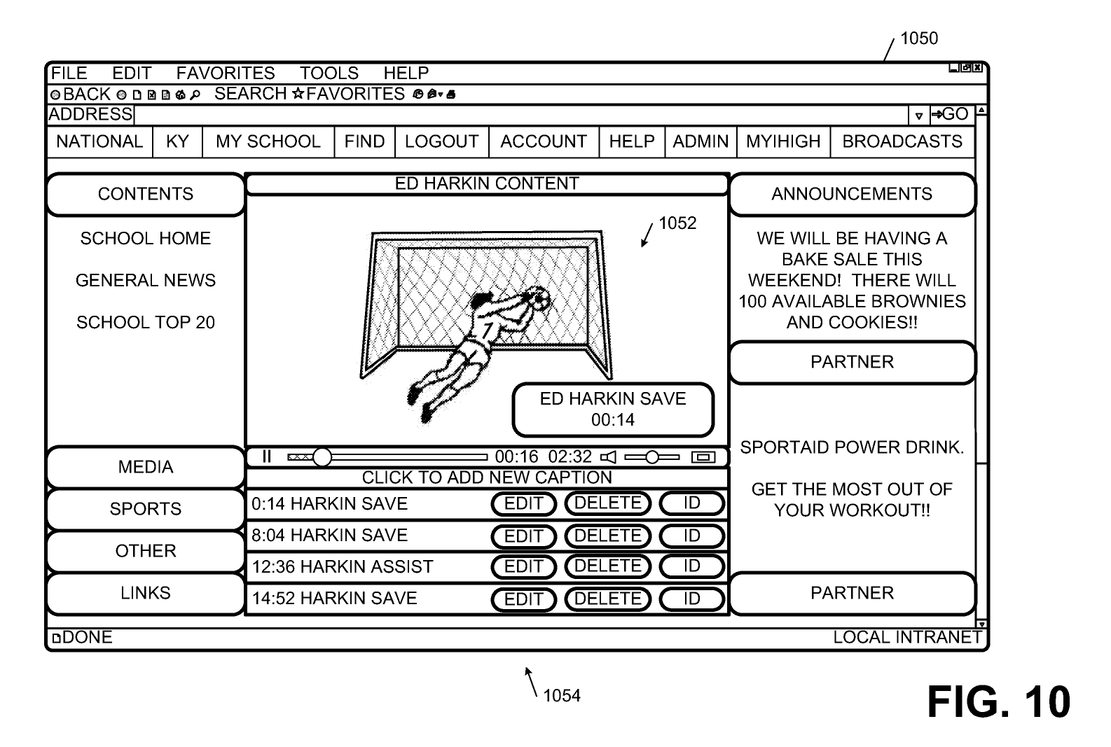

FIG. 10 depicts a user interface 1050 that provides a plurality of different portions of content for a single performer and/or group, according to embodiments disclosed herein. While the user interface 950 associates the highlight clips with the group, the user interface 1050 is accessed from a profile of an individual performer. Accordingly, the tagged portions of the content all relate to that performer. More specifically, in the example of FIG. 10, the tagged content listing area 1054 includes tagged portions of content of a common performer (e.g., Ed Harkin), which are provided in a content area 1052.

As discussed above, a user may designate the types of highlights to view, such as saves, assists, particular games, etc. However in the user interface 1050, all the highlight clips will have been tagged with that performer. Additionally, in some embodiments, an administrator and/or performer may further designate other criteria for providing in the user interface 1050. More specifically, if Ed Harkin wishes to also include highlights of his teammates, he may designate this preference, such that the tagged content listing area 1054 may provide tagged content for all the Lexington Dragons.

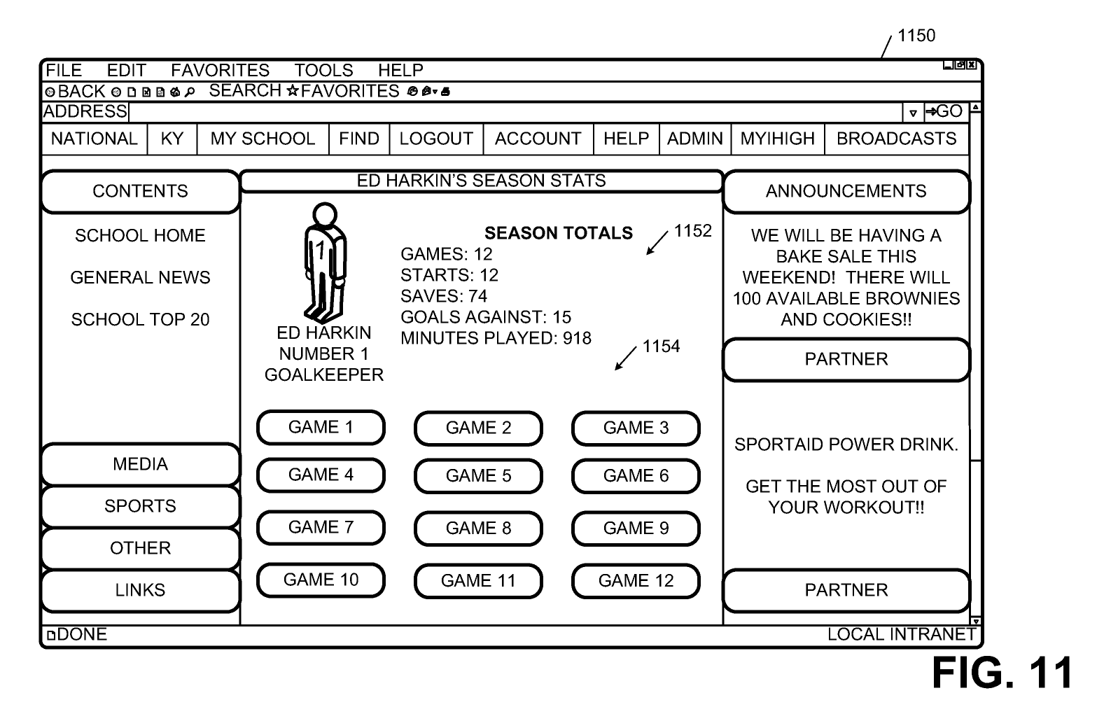

FIG. 11 depicts a user interface 1150 that provides a performer profile in a performance social network, according to one or more embodiments shown and described herein. As illustrated, in response to the season stats option 652 in FIG. 6, the user interface 1150 may be provided. Additionally, the user interface 1150 may include a season stats area 1152 and a game option area 1154. The season stats area 1152 may include cumulative statistics for the performer over a season (or other designated time period). While the statistics may be manually entered, in some embodiments, the statistics may be determined based on tagged data described above. More specifically, when a user tags Ed Harkin for making a save, as described with reference to FIGS. 7-10, the performance social network may additionally update Ed Harkin's season statistics (and game statistics) in the user interface 1050. Further, by selecting one of the game options, in-game statistics may be provided in a similar manner.

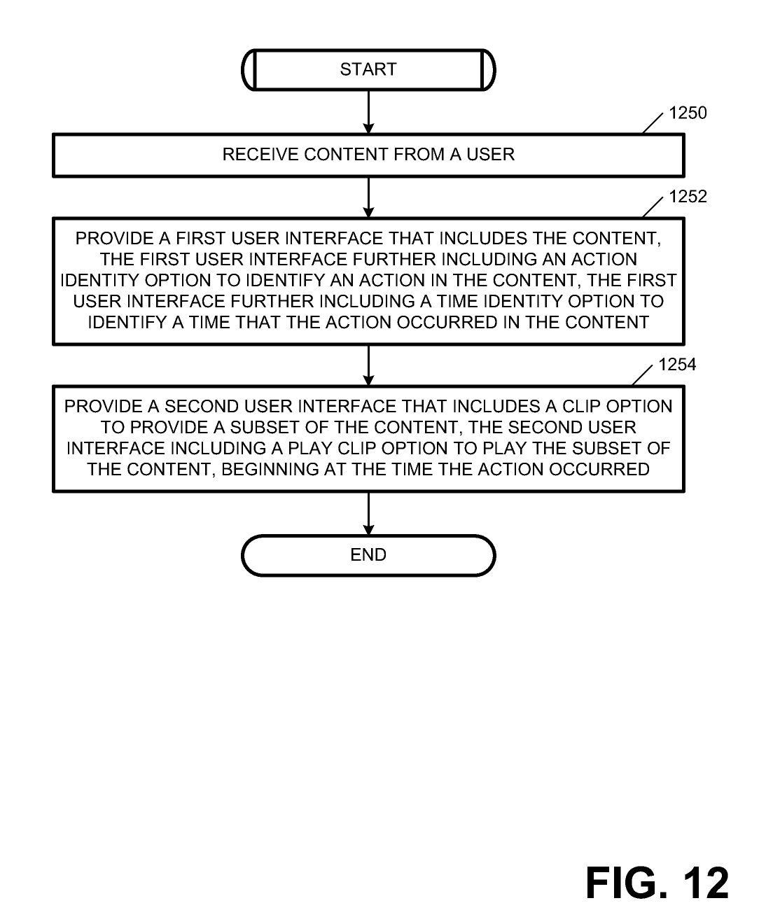

FIG. 12 depicts a flowchart for identifying content, according to one or more embodiments shown and described herein. As illustrated in block 1250, content may be received from a user. In block 1252, a first user interface may be provided. The first user interface may include the content and an action identity option to identify an action in the content. The user interface may further include a time identity option to identify a time that the action occurred in the content. In block 1254, a second user interface may be provided that includes a content option to provide a subset of the content. The second interface may additionally include a play clip option to play the subset of the content, beginning at the time the action occurred.

Embodiments disclosed herein provide systems and methods for identifying portions of content and linking those portions to a performance social network. Accordingly, the portions of content may be provided via tags and/or metadata that references portions of the content such that the portions of content may be dynamically provided without greatly affecting overall storage requirements. Further, the information provided in the tags may be additionally liked to the performance social network for updating statistics and/or providing other information.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for content identification and linking, comprising:
receiving content from a user;
providing a first user interface that comprises the content, the first user interface further comprising an action identity option to identify an action in the content, the first user interface further comprising a time identity option to identify a time that the action occurred in the content; and
providing, by a computing device, a second user interface that comprises a clip option to provide a subset of the content, the second user interface comprising a play clip option to play the subset of the content, beginning approximately at the time the action occurred.

2. The method of claim 1, wherein the first user interface and the second user interface are provided as part of a performance social network.

3. The method of claim 1, further comprising:
receiving an identification of a performer in the content; and
providing an option to access the subset of the content on a profile of the performer.

4. The method of claim 1, further comprising:
receiving a user input identifying the action and a performer involved in the action; and
updating a statistic of the performer on a performance social network.

5. The method of claim 1, further comprising storing tags for a plurality of different clips of content, the tags identifying a common performer in the plurality of different clips of content, the tags permitting the plurality of different clips of content to be accessed from a profile of a performer as a single stream of content.

6. The method of claim 1, further comprising:
determining a group associated with the content;
determining a group statistic for the group in the content; and
updating a group statistic for the group on a profile of the group on a performance social network.

7. The method of claim 1, further comprising:
receiving data that describes the action; and
adding the data as a caption to the content.

8. A system for content identification and linking, comprising:
a memory component that stores logic that, when executed by the system, causes the system to perform at least the following:
receive video content on a performance social network, the performance social network comprising a group profile for a group and a performer profile for a performer, the performer profile being established within the group profile;
provide the video content on the performance social network;
provide an action identity option on the performance social network to identify an action in the video content;
provide a time identity option to identify a time that the action occurred in the video content;
provide a clip option on the performance social network for identifying a subset of the video content;
provide a performer identity option on the performance social network for identifying the performer performing the action within the video content; and
provide a play clip option on the performance social network to play the subset of the video content, beginning at the time the action occurred.

9. The system of claim 8, wherein the logic further causes the system to perform at least the following:
receive an identification of the performer in the video content; and
provide an option to access the subset of the video content on a profile of the performer.

10. The system of claim 8, wherein the logic further causes the system to perform at least the following:
receive a user input identifying the action and the performer involved in the action; and
update a statistic of the performer on the performance social network.

11. The system of claim 8, wherein the logic further causes the system to store tags for a plurality of different clips of content, the tags identifying a common performer in the plurality of different clips of content, the tags permitting the plurality of different clips of content to be accessed from a profile of the performer as a single stream of content.

12. The system of claim 8, wherein the logic further causes the system to perform at least the following:
determine that the group is associated with the video content;
determine a group statistic for the group in the video content; and
update a group statistic for the group on the group profile.

13. The system of claim 8, wherein the logic further causes the system to perform at least the following:
receive data that describes the action; and
add the data as a caption to the video content.

14. A non-transitory computer-readable medium for content identification and linking that stores logic that when executed by a computing device, causes the computing device to perform at least the following:
receive video content on a performance social network;
provide the video content on the performance social network;
provide an action identity option on the performance social network to identify an action in the video content;
provide a time identity option to identify a time that the action occurred in the video content;
provide a clip option on the performance social network for identifying a subset of the video content;
provide a performer identity option on the performance social network for identifying a performer performing the action within the video content; and
provide a play clip option on the performance social network to play the subset of the video content, beginning at the time the action occurred.

15. The non-transitory computer-readable medium of claim 14, wherein the video content is provided on at least one of the following: a performer profile, a group profile to which the performer belongs, and a page on the performance social network associated with a user of the performance social network.

16. The non-transitory computer-readable medium of claim 14, wherein the logic further causes the computing device to perform at least the following:
receive an identification of the performer in the content; and
providing an option to access the subset of the content on a profile of the performer on the performance social network.

17. The non-transitory computer-readable medium of claim 14, wherein the logic further causes the computing device to perform at least the following:
receive a user input identifying the action and the performer involved in the action; and
update a statistic of the performer on the performance social network.

18. The non-transitory computer-readable medium of claim 14, wherein the logic further causes the computing device to store tags for a plurality of different clips of content, the tags identifying a common performer in the plurality of different clips of content, the tags permitting the plurality of different clips of content to be accessed from a profile of the performer on the performance social network as a single stream of content.

19. The non-transitory computer-readable medium of claim 14, wherein the logic further causes the computing device to perform at least the following:
determine a group associated with the content;
determine a group statistic for the group in the content; and
update a group statistic for a group profile of the performance social network.

20. The non-transitory computer-readable medium of claim 14, wherein the logic further causes the computing device to perform at least the following:
receive data that describes the action; and
add the data as a caption to the content.
